(19) United States
(12) Patent Application Publication
(10) Pub. No.: US 2010/0289707 A1
(43) Pub. Date: Nov. 18, 2010

(54) ANTENNA AND RADIO COMMUNICATION APPARATUS

(75) Inventor: Ayumi TAKAMURA, Ishikawa-ken (JP)

Correspondence Address: Studebaker & Brackett PC, One Fountain Square, 11911 Freedom Drive, Suite 750, Reston, VA, 20190, US

(73) Assignee: MURATA MANUFACTURING CO., LTD., Kyoto-fu (JP)

(21) Appl. No.: 12/779,748

(22) Filed: May 13, 2010

(30) Foreign Application Priority Data
May 14, 2009 (JP) 2009-117302

(51) Int. Cl. H01Q 9/04; H01Q 1/24

(52) U.S. Cl. 343/702; 343/700 MS

(57) ABSTRACT

A ground electrode is formed on upper and lower surfaces of a substrate. Along a part of one side of the substrate, a non-ground area is formed on the upper and lower surfaces of the substrate. In the non-ground area on the upper surface of the substrate, a substrate-side radiation electrode is formed along an edge of the substrate. An earth terminal at one end of the substrate-side radiation electrode is electrically connected to the ground electrode or is grounded. A dielectric-block-side radiation electrode and a capacitance forming electrode are formed on a dielectric block. There is a capacitive coupling portion in an inter-electrode gap between an end of the dielectric-block-side radiation electrode and an end of the capacitance forming electrode. A capacitor is connected in series in the middle of the substrate-side radiation electrode.

### CROSS REFERENCE TO RELATED APPLICATIONS

The present application claims priority to Japanese Patent Application No. 2009-117302 filed May 14, 2009, the entire contents of this application being incorporated herein by reference in its entirety.

### BACKGROUND

1. Field of the Invention

The present invention relates to an antenna used for a radio communication apparatus, such as a mobile phone terminal, and a radio communication apparatus including the antenna.

2. Description of the Related Art

Japanese Unexamined Patent Application Publications Nos. 2003-347835 and 11-251815 each disclose an antenna in which a radiation electrode is formed on a dielectric block, and the antenna is configured such that the radiation electrode is capacitively fed.

FIG. 1 illustrates a cross-sectional structure of the antenna disclosed in Japanese Unexamined Patent Application Publication No. 2003-347835. In an antenna unit illustrated in FIG. 1, an end portion 5α of a feed radiation electrode 5 is formed inside a dielectric base 4. The end portion 5α inside the dielectric base 4 faces a feed electrode pad 11 formed on a surface of a substrate 3, so that a capacitance is formed between the end portion 5α and the feed electrode pad 11. A signal from a signal source 7 is fed to the feed radiation electrode 5 through the capacitance between the feed electrode pad 11 and the end portion 5α of the feed radiation electrode 5. The antenna of FIG. 1 is a λ/2 antenna in which the feed radiation electrode 5 is open at both ends. The radiation electrode (i.e., feed radiation electrode 5) of the antenna is formed only on the dielectric block (i.e., dielectric base 4). A ground electrode 8 is disposed on the backside of the antenna.

The antenna disclosed in Japanese Unexamined Patent Application Publication No. 11-251815 is an antenna in which electrodes are formed on a dielectric block. A radiation electrode of the antenna is grounded at one end, while the other end faces and is capacitively coupled to a ground electrode. This antenna is a λ/4 antenna that is capacitively fed from immediately beside the grounded portion. The radiation electrode of this antenna is formed only on the dielectric block. No ground electrode is formed in an area where the antenna is mounted.

The antennas disclosed in Japanese Unexamined Patent Application Publications Nos. 2003-347835 and 11-251815 are antennas in which an electrode is formed on a dielectric block. This means that a dielectric block of large size is required to obtain a desired resonance frequency. It may be possible to form a radiation electrode on a substrate. However, a substrate (e.g., circuit board) typically suffers a high dielectric loss, which may lead to low antenna efficiency.

### SUMMARY

Embodiments consistent with the claimed invention have been conceived to solve the problems described above and to provide an antenna having high antenna efficiency, and a radio communication apparatus including the antenna.

According to an exemplary embodiment, an antenna includes a radiation electrode having a capacitive coupling portion at a first end and grounded at a second end; a dielectric block having the capacitive coupling portion thereon; a substrate having the second end thereon, the substrate having the dielectric block mounted thereon; and a capacitor inserted in series with the radiation electrode on the substrate.

This configuration reduces the area of high electromagnetic field intensity inside the substrate, reduces a dielectric loss in the substrate, and increases antenna efficiency.

The antenna may further include a feed electrode electrically connected to the capacitive coupling portion, disposed on the substrate, and grounded at one end.

As compared to another configuration where the feed electrode is not grounded at one end, this configuration lowers the resonance frequency of the antenna and provides an electrode configuration having an advantage in reducing the size of the antenna.

In the antenna, the capacitor may be disposed between the second end of the radiation electrode and the center of the radiation electrode.

This configuration further reduces the area of high electromagnetic field intensity inside the substrate and increases antenna efficiency.

According to another examplary embodiment, a radio communication apparatus includes an antenna having any of the configurations described above, and a housing having the antenna therein.

Other features, elements, characteristics and advantages of the embodiments consistent with the claimed invention will become more apparent from the following detailed description of the examplary embodiments with reference to the attached drawings.

### BRIEF DESCRIPTION OF THE DRAWINGS

FIG. 1 is a cross-sectional view of an antenna disclosed in Japanese Unexamined Patent Application Publication No. 2003-347835.

FIG. 2A to FIG. 2C are perspective views each illustrating a configuration of a main part of an antenna according to an exemplary first embodiment.

FIG. 3A to FIG. 3C are equivalent circuit diagrams of the three antennas illustrated in FIG. 2A to FIG. 2C.

FIG. 4A is a plan view of the antenna related to the antenna illustrated in FIG. 2A and FIG. 3A.

FIG. 4B shows a field intensity distribution inside a substrate related to the antenna illustrated in FIG. 2A and FIG. 3A.

FIG. 4C shows an analysis of various Q factors obtained at a resonance frequency related to the antenna illustrated in FIG. 2A and FIG. 3A.

FIG. 5A is a plan view of the antenna related to the antenna illustrated in FIG. 2B and FIG. 3B.

FIG. 5B shows a field intensity distribution inside the substrate, and FIG. 5C shows an analysis of various Q factors obtained at a resonance frequency.

FIG. 6A is a plan view of the antenna related to the antenna illustrated in FIG. 2C and FIG. 3C.

FIG. 6B shows a field intensity distribution inside the substrate related to the antenna illustrated in FIG. 2C and FIG. 3C.

FIG. 6C shows an analysis of various Q factors obtained at a resonance frequency.

FIG. 7 shows a field intensity distribution inside the substrate on which a capacitor is disposed near a dielectric block.

FIG. 8 shows how a field intensity distribution on a surface of the substrate changes when the capacitance of the capacitor is changed.

FIG. 9A to FIG. 9C are perspective views each illustrating a configuration of a main part of an antenna according to an exemplary second embodiment.

FIG. 10A to FIG. 10C are equivalent circuit diagrams of the three antennas illustrated in FIG. 9A to FIG. 9C.

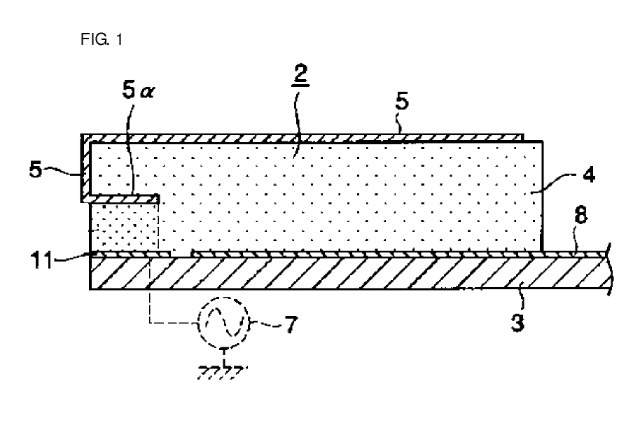

### DETAILED DESCRIPTION

Hereinafter, with reference to the above-listed figures, the features of various exemplary embodiments consistent with the present invention will be described in more detail.

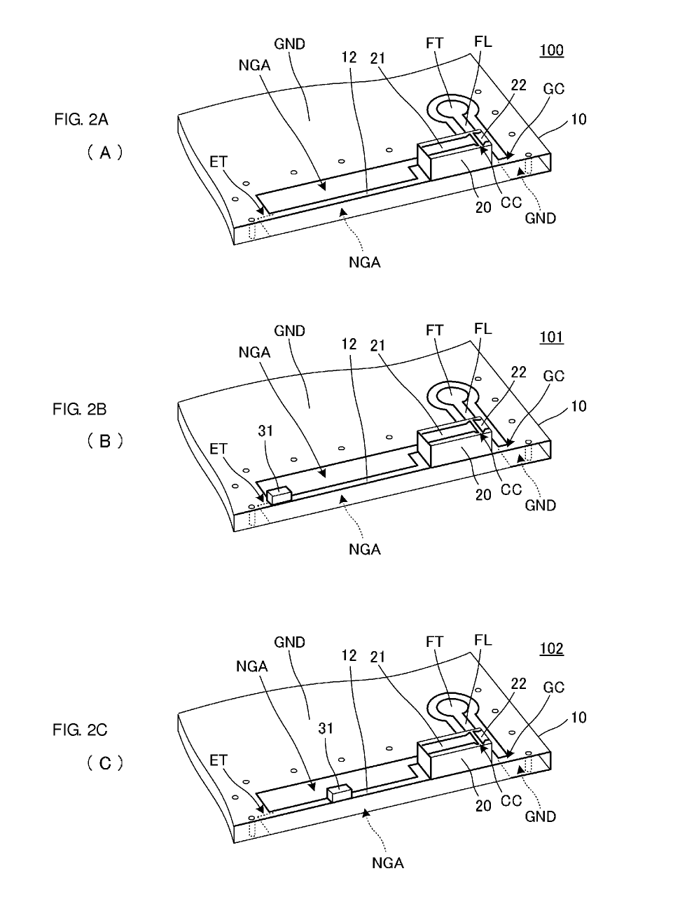

An antenna according to an exemplary first embodiment directed to a radio communication apparatus including the antenna will now be described with reference to FIG. 2A to FIG. 8.

FIG. 2A to FIG. 2C are perspective views each illustrating a configuration of a main part of an antenna. FIG. 2A is a perspective view of an antenna 100 in which there is no capacitor connected in series with a radiation electrode. FIG. 2B and FIG. 2C are perspective views of an antenna 101 and an antenna 102, respectively, each having a capacitor connected in series with a radiation electrode. FIG. 2A is presented for preliminary explanation of a configuration of an antenna according to the first embodiment.

As illustrated in FIG. 2A, a ground electrode GND is formed on upper and lower surfaces of a substrate 10. Along a part of one side of the substrate 10, a non-ground area NGA is formed on the upper and lower surfaces of the substrate 10. A feed line FL is formed on the upper surface of the substrate 10. One end of the feed line FL is formed as a feed terminal FT, while the other end of the feed line FL is connected to the ground electrode GND at a ground connecting portion GC. There is a non-electrode forming portion between the feed line FL and the ground electrode GND. The feed line FL, the non-electrode forming portion, and the ground electrode GND form a coplanar line.

In the non-ground area NGA on the upper surface of the substrate 10, a substrate-side radiation electrode 12 is formed along an edge of the substrate 10. An earth terminal ET at one end of the substrate-side radiation electrode 12 is electrically connected to the ground electrode GND or is grounded.

A dielectric-block-side radiation electrode 21 and a capacitance forming electrode 22 are formed on a substantially hexahedral dielectric block 20. There is a capacitive coupling portion CC in an inter-electrode gap between an end of the dielectric-block-side radiation electrode 21 and an end of the capacitance forming electrode 22. The dielectric block 20 having these electrodes thereon is mounted in the non-ground area NGA on the substrate 10. Thus, an end of the dielectric-block-side radiation electrode 21 is electrically connected to an end of the substrate-side radiation electrode 12, while an end of the capacitance forming electrode 22 is electrically connected to a portion near the ground connecting portion GC of the feed line FL.

In the example illustrated in FIG. 2B, a capacitor 31 is mounted near the earth terminal ET of the substrate-side radiation electrode 12 such that the capacitor 31 is connected in series with the substrate-side radiation electrode 12.

In the example illustrated in FIG. 2C, the capacitor 31 is mounted in the middle of the substrate-side radiation electrode 12. That is, the capacitor 31 is mounted substantially at the center between the earth terminal ET and a connecting portion of the substrate-side radiation electrode 12, and the connecting portion is connected to the dielectric-block-side radiation electrode 21.

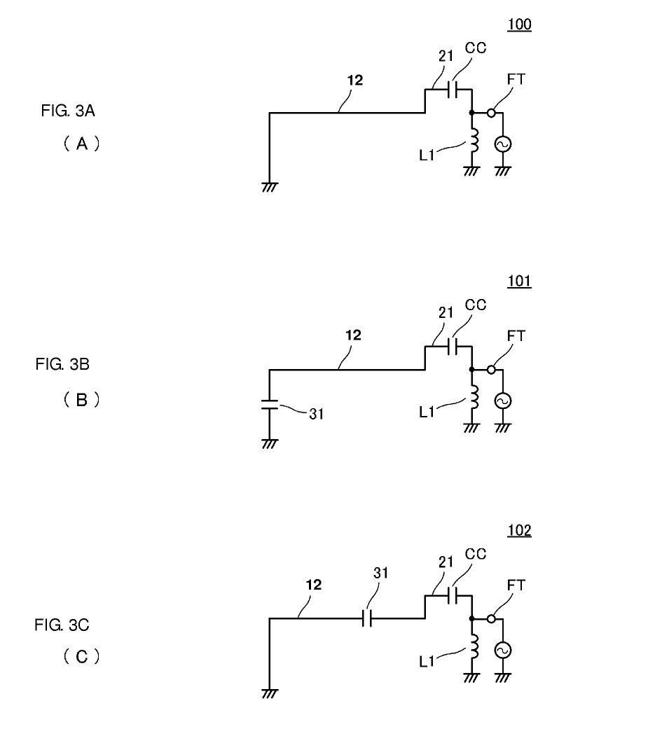

FIG. 3A to FIG. 3C are equivalent circuit diagrams of the three antennas 100, 101, and 102 illustrated in FIG. 2A to FIG. 2C. In FIG. 3A to FIG. 3C, the substrate-side radiation electrode 12 and the dielectric-block-side radiation electrode 21 act as a single radiation electrode, whose first end is capacitively fed at the capacitive coupling portion CC. In the drawings, an inductor L1 represents inductance that occurs near the ground connecting portion GC of the feed line FL.

When the capacitor 31 is provided near the earth terminal ET of the substrate-side radiation electrode 12 as illustrated in FIG. 2B, a second end of the radiation electrode, the second end being opposite the first end that is the capacitive coupling portion CC, is opened by the capacitor 31 as illustrated in FIG. 3B.

When the capacitor 31 is provided in the middle of the substrate-side radiation electrode 12 as illustrated in FIG. 2C, the capacitor 31 is inserted in the middle of the radiation electrode as illustrated in FIG. 3C.

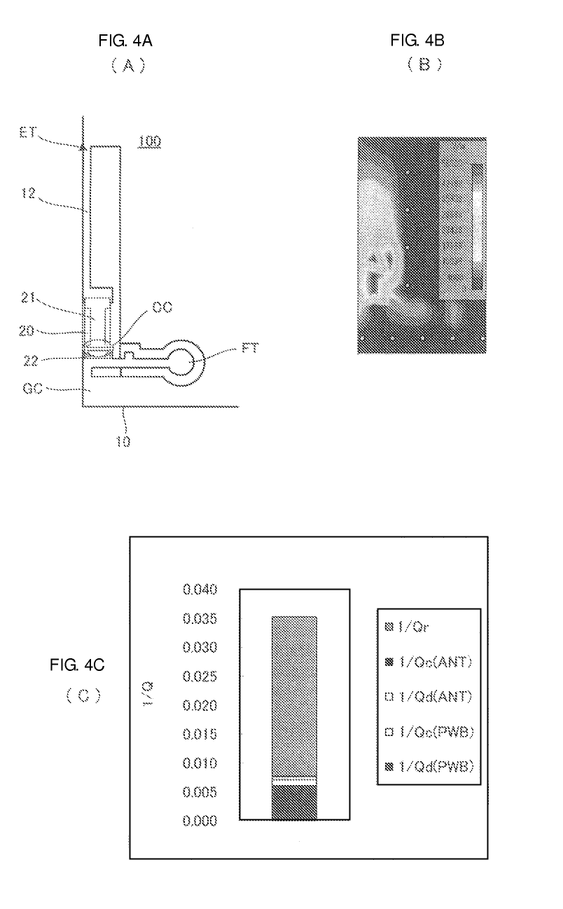

FIG. 4A to FIG. 4C are diagrams related to the antenna 100 illustrated in FIG. 2A and FIG. 3A. FIG. 4A is a plan view of the antenna 100, FIG. 4B shows a field intensity distribution inside the substrate 10, and FIG. 4C shows an analysis of various Q factors obtained at a resonance frequency.

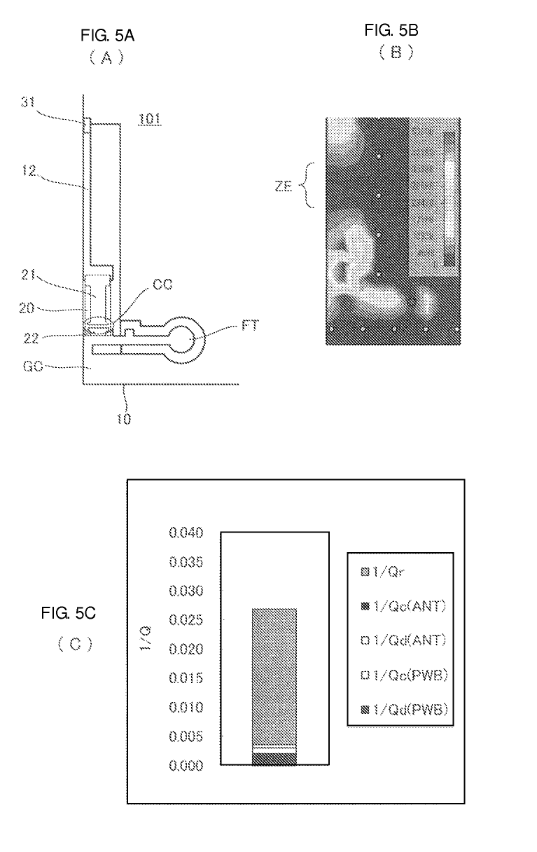

FIG. 5A to FIG. 5C are diagrams related to the antenna 101 illustrated in FIG. 2B and FIG. 3B. FIG. 5A is a plan view of the antenna 101. FIG. 5B shows a field intensity distribution inside the substrate 10, and FIG. 5C shows an analysis of various Q factors obtained at a resonance frequency.

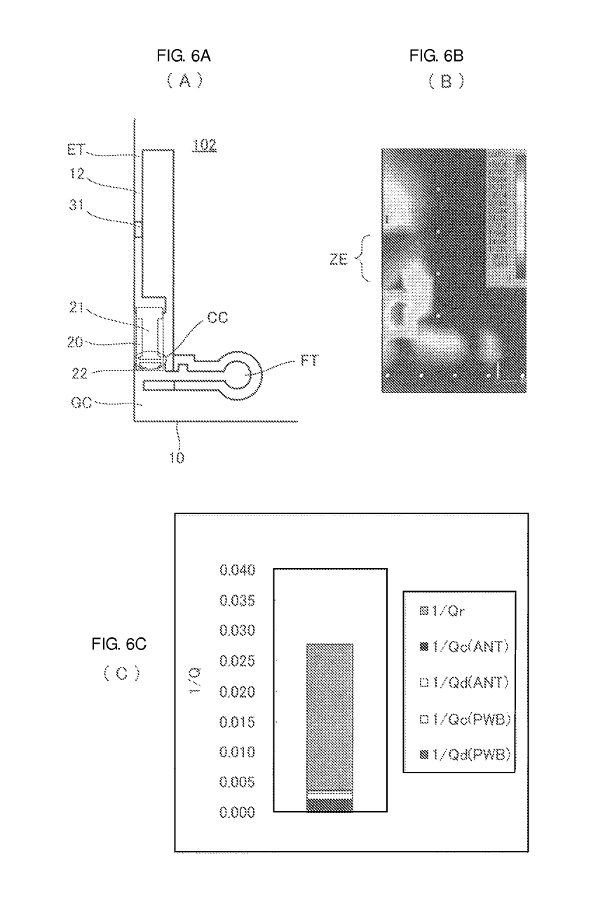

FIG. 6A to FIG. 6C are diagrams related to the antenna 102 illustrated in FIG. 2C and FIG. 3C. FIG. 6A is a plan view of the antenna 102, FIG. 6B shows a field intensity distribution inside the substrate 10, and FIG. 6C shows an analysis of various Q factors obtained at a resonance frequency.

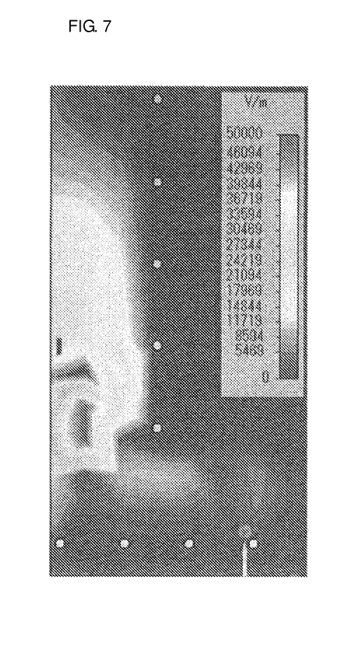

FIG. 7 shows a field intensity distribution inside the substrate 10 on which the capacitor 31 is disposed near the dielectric block 20.

In the examples described above, a capacitance value of the capacitor 31 and that on the dielectric block 20 are set to be the same.

As illustrated in FIG. 2A, when no capacitor is inserted in the substrate-side radiation electrode 12, the antenna 100 performs a λ/4 operation (i.e., the radiation electrode resonates at a quarter wavelength), where λ denotes one wavelength at a resonance frequency. FIG. 4B is a diagram in which field intensity inside the substrate 10 (i.e., at a position about 2 mm inside the upper surface of the substrate 10), as viewed in the same direction as in FIG. 4A, is represented by gradations. The field intensity is calculated using an electromagnetic field simulator.

As shown, the electric field is substantially zero at the earth terminal ET of the substrate-side radiation electrode 12, and reaches a maximum level at the capacitive coupling portion CC. FIG. 4B thus shows that the electromagnetic field is distributed widely inside the substrate 10.

On the other hand, as illustrated in FIG. 2B and FIG. 2C, when the capacitor 31 is inserted in series with the substrate-side radiation electrode 12 on the substrate 10, since the radiation electrode including the substrate-side radiation electrode 12 and the dielectric-block-side radiation electrode 21 is open at both ends, a λ/2 operation takes place (i.e., the radiation electrode resonates at a half wavelength). To obtain a resonance frequency equal to that of the antenna 100 illustrated in FIG. 2A, a capacitance value at the capacitive coupling portion CC is set to be greater than that at the capacitive coupling portion CC of the antenna 100.

As shown in FIG. 5B and FIG. 6B, a portion at which the capacitor 31 is inserted and the capacitive coupling portion CC correspond to respective peaks of the field intensity distribution. A low field intensity area ZE in which the field intensity is substantially zero appears between the peaks.

In the substrate 10 shown in FIG. 5B and FIG. 6B, the area where the field intensity is high is smaller than that in the substrate 10 shown in FIG. 4B, while the low field intensity area ZE is larger than that in the substrate 10 shown in FIG. 4B.

If the capacitor 31 is placed in series with the substrate-side radiation electrode 12 at a position near the dielectric block 20, as shown in FIG. 7, a λ/4 operation takes place on the line extending from the earth terminal ET to the capacitor 31 on the substrate 10, and the low field intensity area ZE in which the field intensity is substantially zero appears in the middle of the radiation electrode. However, since this area is very small, the field intensity inside the substrate 10 is not significantly reduced, and an improvement in antenna efficiency is limited.

When an electric field is generated inside the substrate 10, which is a dielectric substrate, a dielectric loss of the substrate 10 occurs. The dielectric Q of a substrate is generally low. For example, the dielectric Q of a glass epoxy substrate is about 40. In the antenna 100 illustrated in FIG. 2A, the field intensity inside the substrate 10 is high, and thus a high dielectric loss occurs.

When the radiation Q is expressed as Qr, the conductor Q is expressed as Qc, and the dielectric Q is expressed as Qd, their reciprocals are a radiation loss, a conductor loss, and a dielectric loss, respectively. A conductor loss 1/Qc(ANT) and a dielectric loss 1/Qd(ANT) occur in the dielectric block 20, while a conductor loss 1/Qc(PWB) and a dielectric loss 1/Qd(PWB) occur in the substrate 10. Therefore, an antenna Qo can be defined by the following equation:

1/Qo=1/Qr+1/Qc(ANT)+1/Qd(ANT)+1/Qc(PWB)+1/Qd(PWB)

As is obvious from the comparison of FIG. 5C and FIG. 6C with FIG. 4C, the dielectric loss (1/Qd(PWB)) in the substrate 10 is reduced to about one-third by inserting the capacitor 31. The reduction of the dielectric loss in the substrate 10 improves the antenna efficiency of the antenna 101 or 102 by about 0.5 dB, as compared to the antenna 100.

To reduce electromagnetic field intensity inside the substrate 10, it is important to ensure that the field intensity is substantially zero at the substrate-side radiation electrode 12.

It is preferable that the capacitor 31 be inserted between the earth terminal ET (i.e., the second end of the radiation electrode) and the center of the substrate-side radiation electrode 12. This is because placing the capacitor 31 near the dielectric block 20 results in an increased length of a portion between the capacitor 31 and the earth terminal ET along the substrate-side radiation electrode 12, and causes λ/4 resonance to occur at this portion. When λ/4 resonance occurs, the size of the low field intensity area ZE, where the field intensity inside the substrate 10 is substantially zero, is reduced. Therefore, the field intensity in the substrate 10 is not significantly reduced, and an improvement is antenna efficiency is limited.

It is thus preferable that the capacitor 31 be inserted at a position closer to the earth terminal ET than to the dielectric block 20. This is because moving the capacitor 31 away from the capacitive coupling portion CC creates the low field intensity area ZE on the substrate-side radiation electrode 12 and reduces the dielectric loss of the substrate 10.

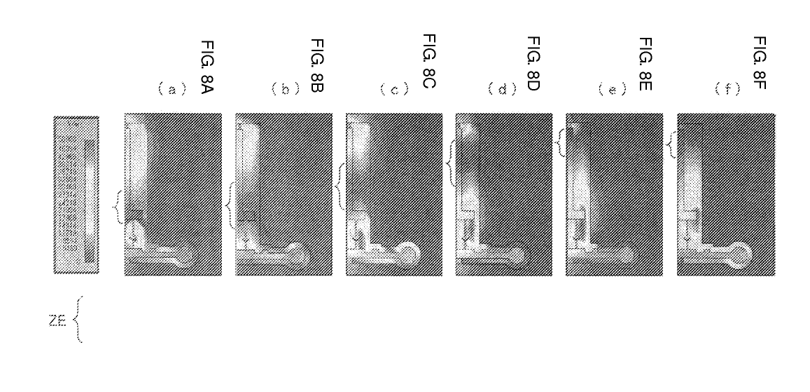

FIG. 8 shows how a field intensity distribution on the surface of the substrate 10 at the resonance frequency changes when the capacitance of the capacitor 31 is changed. Here, the capacitor 31 is mounted near the earth terminal ET as illustrated in FIG. 2B. When a capacitance value on the dielectric block 20 is about 1 pF, the capacitance of the capacitor 31 in (a) to (f) of FIG. 8 is as follows:
(a) 0.3 pF
(b) 0.5 pF
(c) 1.0 pF
(d) 3.0 pF
(e) 10 pF
(f) 15 pF

The position of the low field intensity area ZE is determined by a balance between the capacitance value of the capacitor 31 and that of the capacitive coupling portion CC on the dielectric block 20. As the two capacitance values become closer, the size of the low field intensity area ZE appearing on the substrate-side radiation electrode 12 increases and a dielectric loss in the substrate 10 decreases accordingly.

As shown in FIG. 8, the size of the low field intensity area ZE is large when the capacitance of the capacitor 31 is in the 0.5 pF to 3.0 pF range. Therefore, the capacitance value of the capacitor 31 is set to a value of substantially the same order as the capacitance value of the capacitive coupling portion CC on the dielectric block (i.e., a value within the range of 0.5 to 3.0 times the capacitance value of the capacitive coupling portion CC).

Incidentally, reducing the capacitance value of the capacitor 31 without changing the capacitance value of the capacitive coupling portion CC on the dielectric block 20 (i.e., without changing the permittivity of the dielectric block 20 or without changing the electrode size) increases the resonance frequency of the antenna. When the capacitance value of the capacitor 31 is reduced, sensitivity to a frequency drift increases.

On the other hand, when the capacitance value of the capacitor 31 is increased, the resonance frequency of the antenna decreases and becomes closer to a resonance frequency obtained when the capacitor 31 is not inserted. Thus, varying the capacitance value of the capacitor 31 inserted in series changes the resonance frequency of the antenna. This phenomenon can be used for frequency adjustment. In this case, since reducing the capacitance value of the capacitor 31 results in higher sensitivity (i.e., larger frequency drift), it is not preferable to use the capacitor 31 having a small capacitance value for the purpose of frequency adjustment.

For frequency adjustment, it is preferable that the capacitance value of the capacitor 31 inserted in series with the radiation electrode be greater than that of the capacitive coupling portion CC on the dielectric block 20, for example, by an order of magnitude (e.g., 10 times) or more.

On the other hand, since the present embodiment seeks to reduce the field intensity inside the substrate 10 having the substrate-side radiation electrode 12 thereon, the capacitance value of the capacitor 31 inserted in the substrate-side radiation electrode 12 is set to be close to that at the capacitive coupling portion CC on the dielectric block 20. Thus, the low field intensity area ZE appears on the substrate-side radiation electrode 12, a dielectric loss in the substrate 10 is reduced, and an antenna with high antenna efficiency can be realized.

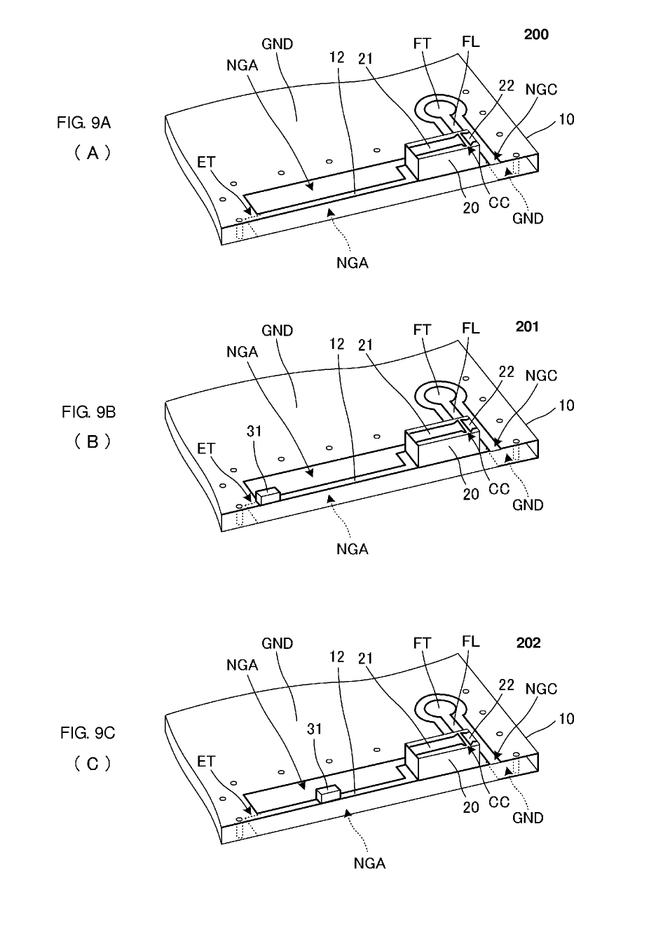

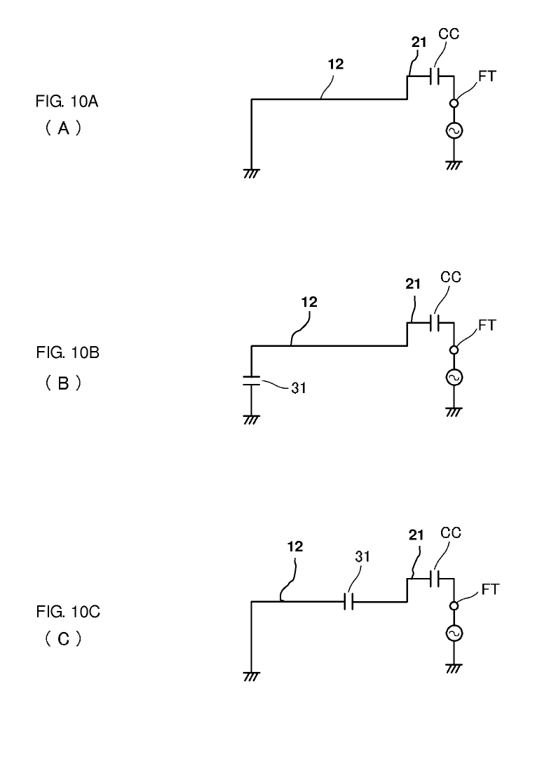

An antenna according to an exemplary second embodiment directed a radio communication apparatus including the antenna will now be described with reference to FIG. 9A to FIG. 10C.

FIG. 9A to FIG. 9C are perspective views each illustrating a configuration of a main part of an antenna. FIG. 9A is a perspective view of an antenna 200 in which there is no capacitor connected in series with a radiation electrode. FIG. 9B and FIG. 9C are perspective views of an antenna 201 and an antenna 202, respectively, each having a capacitor connected in series with a radiation electrode. FIG. 9A is presented for preliminary explanation of a configuration of an antenna according to the second embodiment.

A difference with the antennas 100, 101, and 102 illustrated in FIG. 2A to FIG. 2C is the configuration of the feed line FL. In the antennas 200, 201, and 202, the feed line FL is formed as the feed terminal FT at one end, and is not grounded (and has a non-ground connecting portion NGC) at the other end. The other configurations are the same as those of the antennas 100, 101, and 102 illustrated in FIG. 2A to FIG. 2C.

FIG. 10A to FIG. 10C are equivalent circuit diagrams of the three antennas 200, 201, and 202 illustrated in FIG. 9A to FIG. 9C. In FIG. 10A to FIG. 10C, the substrate-side radiation electrode 12 and the dielectric-block-side radiation electrode 21 act as a single radiation electrode, whose first end is capacitively fed at the capacitive coupling portion CC.

As illustrated in FIG. 9A, when the capacitor 31 is not provided in series with the substrate-side radiation electrode 12, the electric field is substantially zero at the earth terminal ET of the substrate-side radiation electrode 12, and reaches a maximum level at the capacitive coupling portion CC, so that the electromagnetic field is distributed widely inside the substrate 10.

On the other hand, as illustrated in FIG. 9B and FIG. 9C, when the capacitor 31 is inserted in series with the substrate-side radiation electrode 12 on the substrate 10, since the radiation electrode including the substrate-side radiation electrode 12 and the dielectric-block-side radiation electrode 21 is open at both ends, a λ/2 operation takes place (i.e., the radiation electrode resonates at a half wavelength). As a result, a portion at which the capacitor 31 is inserted and the capacitive coupling portion CC correspond to respective peaks of the field intensity distribution, and the low field intensity area ZE in which the field intensity is substantially zero appears between the peaks. Thus, a dielectric loss of the substrate 10 is reduced and an antenna having high antenna efficiency can be realized.

While the embodiments consistent with the claimed invention have been described above, it is to be understood that variations and modifications will be apparent to those skilled in the art without departing from the scope and spirit of the appended claims. The scope of the embodiments, therefore, is to be determined solely by the following claims.

What is claimed is:

1. An antenna comprising:
a radiation electrode having a first end, a second end and a capacitive coupling portion at the first end, the radiation electrode being grounded at the second end;
a dielectric block on which the capacitive coupling portion is disposed;
a substrate having the second end of the radiation electrode thereon, the substrate having the dielectric block mounted thereon; and
a capacitor inserted in series with the radiation electrode on the substrate.

2. The antenna according to claim 1, further comprising a feed electrode electrically connected to the capacitive coupling portion, disposed on the substrate, and grounded at one end.

3. The antenna according to claim 2, wherein the capacitor is disposed between the second end of the radiation electrode and the center of the radiation electrode.

4. The antenna according to claim 3, wherein a capacitance value of the capacitor is about 0.5 to 3.0 times a capacitance value at the capacitive coupling portion.

5. The antenna according to claim 2, wherein a capacitance value of the capacitor is about 0.5 to 3.0 times a capacitance value at the capacitive coupling portion.

6. The antenna according to claim 1, wherein the capacitor is disposed between the second end of the radiation electrode and the center of the radiation electrode.

7. The antenna according to claim 6, wherein a capacitance value of the capacitor is about 0.5 to 3.0 times a capacitance value at the capacitive coupling portion.

8. The antenna according to claim 1, wherein a capacitance value of the capacitor is about 0.5 to 3.0 times a capacitance value at the capacitive coupling portion.

9. A radio communication apparatus comprising:
an antenna; and
a housing having the antenna therein, wherein the antenna includes:
a radiation electrode having a first end, a second end and a capacitive coupling portion at the first end, the radiation electrode being grounded at the second end;
a dielectric block on which the capacitive coupling portion is disposed;
a substrate having the second end of the radiation electrode thereon, the substrate having the dielectric block mounted thereon; and
a capacitor inserted in series with the radiation electrode on the substrate.

10. The radio communication apparatus according to claim 9, further comprising a feed electrode electrically connected to the capacitive coupling portion, disposed on the substrate, and grounded at one end.

11. The radio communication apparatus according to claim 10, wherein the capacitor is disposed between the second end of the radiation electrode and the center of the radiation electrode.

12. The radio communication apparatus according to claim 11, wherein a capacitance value of the capacitor is about 0.5 to 3.0 times a capacitance value at the capacitive coupling portion.

13. The radio communication apparatus according to claim 10, wherein a capacitance value of the capacitor is about 0.5 to 3.0 times a capacitance value at the capacitive coupling portion.

14. The radio communication apparatus according to claim 9, wherein the capacitor is disposed between the second end of the radiation electrode and the center of the radiation electrode.

15. The radio communication apparatus according to claim 14, wherein a capacitance value of the capacitor is about 0.5 to 3.0 times a capacitance value at the capacitive coupling portion.

16. The radio communication apparatus according to claim 9, wherein a capacitance value of the capacitor is about 0.5 to 3.0 times a capacitance value at the capacitive coupling portion.
